(19) United States
(12) Patent Application Publication
(10) Pub. No.: US 2010/0022335 A1
(43) Pub. Date: Jan. 28, 2010

(54) CHAIN GUIDER OF A FRONT DERAILLEUR

(76) Inventor: DOUGLAS CHIANG, Taichung Hsien (TW)

Correspondence Address: Chien-Hui Su, P. O. Box 70-121 Taichung, Taichung City, 40899, TW

(21) Appl. No.: 12/177,893

(22) Filed: Jul. 23, 2008

(51) Int. Cl. F16H 9/00

(52) U.S. Cl. 474/80

(57) ABSTRACT

A chain guider of a front derailleur includes an inner plate having an inverted L-shaped connecting structure integrally extending therefrom and an outer plate mounted on the connecting structure. The inner plate is made of metal and the outer plate is made of carbon fiber. The connecting structure includes a top plate and a side plate. The side plate is adhered to the outer plate.

### BACKGROUND OF THE INVENTION

1. Field of the Invention

The present invention relates to a chain guider, and more particularly to a chain guider of a front derailleur for a bicycle.

2. Description of Related Art

A conventional front derailleur in accordance with the prior art comprises a fixed member for being adapted to a bicycle frame, a chain guider for guiding a chain and shifting the chain between different chain wheels, an inner link having one end pivotably coupled to the fixed member and the other end coupled to the chain guider, an outer link having one end pivotably coupled to the fixed member and the other end coupled to the chain guider, a biasing member for biasing the chain guider laterally inwardly, and an actuating arm extending from one end of the outer link for driving the chain guider. When pulling the actuating arm downwardly, the chain guider moves laterally outwardly to shift the chain up so that the chain engages with the large chain wheel. The conventional chain guider in accordance with the prior art includes an inner plate and an outer plate in one-piece structure. The inner plate and the outer plate are made of metal, i.e. stainless. The strength of metal is good, but the weight is high. The rider is burdened with the weight when he/she rides in a long distance or in a competition.

The present invention has arisen to mitigate and/or obviate the disadvantages of the conventional chain guider of a front derailleur.

### SUMMARY OF THE INVENTION

The main objective of the present invention is to provide an improved a chain guider of a front derailleur, in that a high strength and lightweight chain guider of a front derailleur is acquired.

To achieve the objective, the chain guider of a front derailleur comprises an inner plate and an outer plate connected to the inner plate. The inner plate is made of metal. The inner plate has an inverted L-shaped connecting structure integrally extending therefrom. The connecting structure includes a top plate and a side plate to form an inverted L-shape. The top plate is connected to the inner plate and is perpendicular to the inner plate. The side plate is connected to the outer plate and is parallel to the inner plate. The connecting structure has a protection integrally extending from the side plate for adhering to the outer plate. The outer plate is made of carbon fiber and is adhered to the side plate and the protection. One end of the outer plate is fastened with the inner plate by a fastener. A receiving space is defined between the inner plate and the outer plate for receiving a chain.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a chain guider of a front derailleur in accordance with the present invention;

FIG. 2 is an assembled perspective view of the chain guider of a front derailleur in FIG. 1;

FIG. 3 is a perspective schematic view of the chain guider of a front derailleur showing the front derailleur mounts on a bicycle frame;

FIG. 4 is a side plane view of the chain guider of a front derailleur in FIG. 3;

FIG. 5 is a partial cross-sectional view of the chain guider of a front derailleur in FIG. 4 taken along line 5-5; and

FIG. 6 is a cross-sectional view of the chain guider of a front derailleur in FIG. 4 taken along line 6-6.

### DETAILED DESCRIPTION OF THE INVENTION

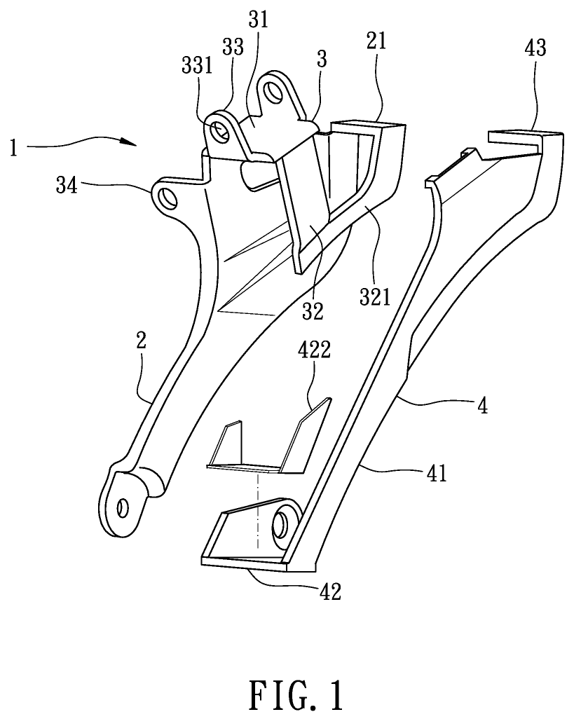

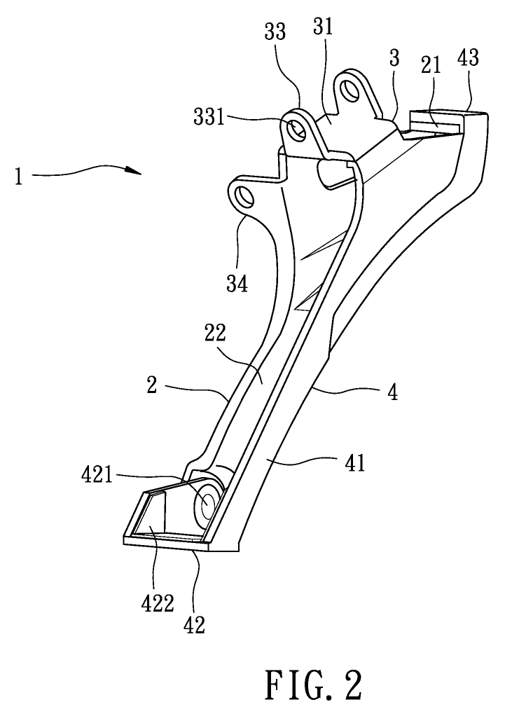

Referring to the drawings and initially to FIGS. 1-2, a chain guider 1 of a front derailleur in accordance with the present invention comprises an inner plate 2 and an outer plate 4 laterally connected to the inner plate 2.

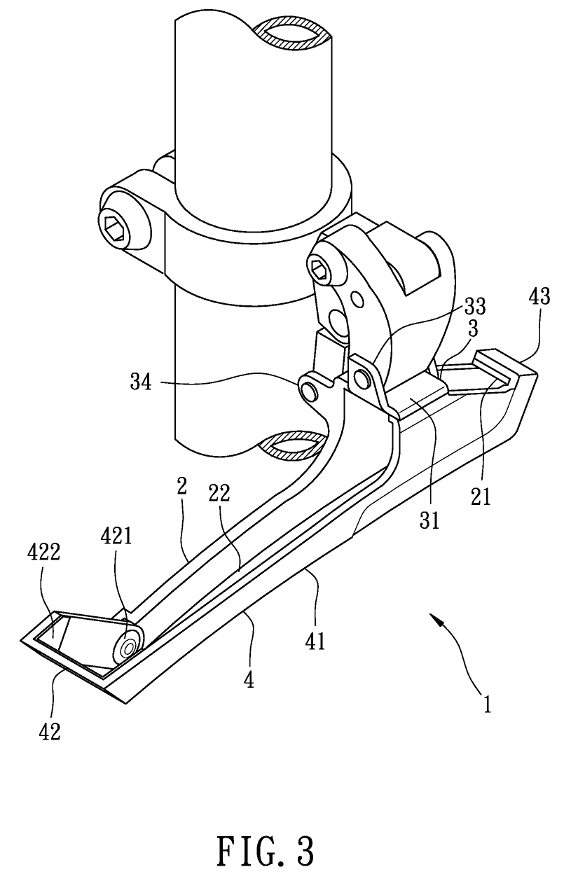

The inner plate 2 is made of metal sheet. The inner plate 2 has a connecting structure 3 integrally and laterally extending therefrom toward the outer plate 4 and connected to the outer plate 4. The connecting structure 3 includes a top plate 31 perpendicularly and outwardly extending from a top of the inner plate 2 and a side plate 32 perpendicularly and downwardly extending from a free end of the top plate 31 to form an inverted L-shape. The connecting structure 3 has a protection 321 extending from a free end of the side plate 32. The inner plate 2 is parallel to the protection 321 and the side plate 32. The inner plate 2 has a bridge 21 integrally extending therefrom and integrally connected to a free end of the protection 321 for enhancing the stiffness and stability of the side plate 32 and the protection 321. The top plate 31 has a pair of ears 33 upwardly extending therefrom. Each ear 33 has a through hole 331 defined therein for mounting with an outer link (see FIG. 3). The inner plate 2 has an ear 34 extending therefrom opposite to the outer plate 4 for mounting with an inner link (see FIG. 3).

The outer plate 4 is made of carbon fiber. The outer plate 4 is laterally mounted on the connecting structure 3; more specifically, the outer plate 4 is adhered to the side plate 32 and the protection 321 of the connecting structure 3. The inner plate 2 and the outer plate 4 also can be adhered when mold forming the outer plate 4. The outer plate 4 includes a middle formed with a body 41, a fastening protrusion 42 inwardly extending from one end of the body 41, and a connecting protrusion 43 inwardly extending from the other end of the body 41. The body 41 is adhered to the side plate 32 and the protection 321, and therefore the body 41 is essentially parallel to the inner plate 2. The fastening protrusion 42 is connected to one end of the inner plate 2 and fastened by a fastener 421. The connecting protrusion 43 is adhered to the bridge 21.

The chain guider 1 further comprises a U-shaped plate 422 disposed on the fastening protrusion 42 of the outer plate 4. The U-shaped plate 422 has a higher strength than that of the outer plate 4. A receiving space 22 is defined between the inner plate 2 and the outer plate 4 for allowing a chain passing the chain guider 1 during operating.

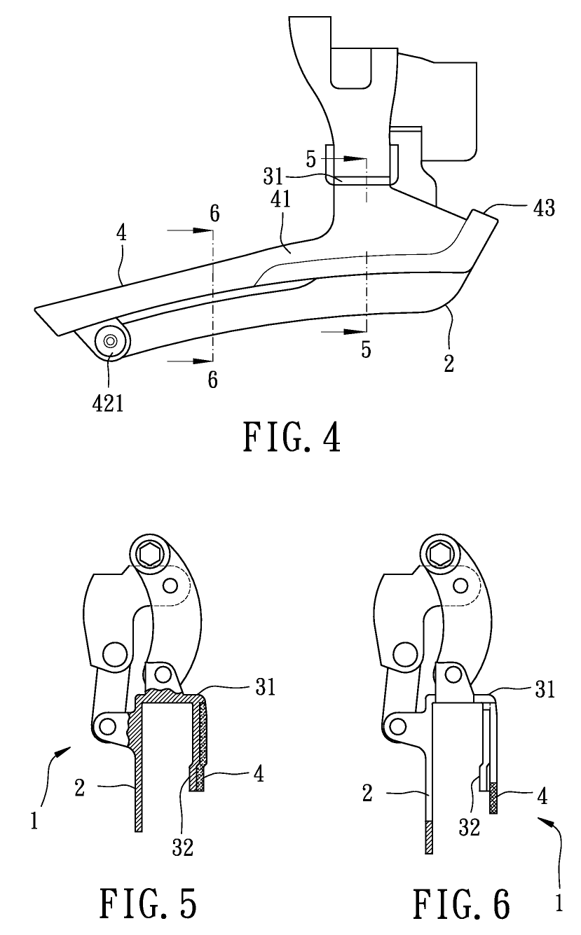

Referring to FIGS. 3-6, the installation of the chain guider 1 of the front derailleur is illustrated. The inner plate 2 is provided to shift the chain from small sprocket to large sprocket, and therefore the inner plate 2 sustains high stress and abrasion. The outer plate 4 is provided to push the chain from large sprocket to small sprocket, and therefore the outer plate 4 sustains low stress and abrasion. For those reasons, the inner plate 2 has a high strength than the outer plate 4. A width of the inner plate 2 is wider than that of the outer plate 4 to increase a contact area in the inner plate 2 and reduce a weight of the out plate 4. Moreover the protection 321 is provided as a high strength and wear-resisting area when the outer plate 4 pushes the chain. The U-shaped plate 422 is also provided to prevent the outer plate 4 from wearing. Furthermore, the fastening protrusion 42 and the connecting protrusion 43 provide a solid connection to prevent the outer plate 4 from deforming. The chain guider 1 is light by using carbon fiber, but is high strength and stability.

Although the invention has been explained in relation to its preferred embodiment, it is to be understood that many other possible modifications and variations can be made without departing from the spirit and scope of the invention as hereinafter claimed.

1. A chain guider of a front derailleur comprising:
an inner plate having an inverted L-shaped connecting structure integrally extending therefrom, the connecting structure having a protection integrally extending therefrom;
an outer plate mounted on the connecting structure and adhered to the protection, the outer plate including a fastening protrusion inwardly extending from one end thereof, the fastening protrusion connected to the inner plate and fastened by a fastener;
a receiving space defined between the inner plate and the outer plate for allowing a chain passing the chain guider during operating; and
a U-shaped plate disposed on the fastening protrusion of the outer plate, a strength of the U-shaped plate being higher than that of the outer plate, wherein the U-shaped plate is provided to prevent the outer plate from wearing by the chain.

2. The chain guider as claimed in claim 1, wherein the outer plate is made of carbon fiber and is adhered to the connecting structure.

3. The chain guider as claimed in claim 1, wherein the connecting structure includes a top plate and a side plate to form an inverted L-shape, the side plate connected to the outer plate and being parallel to the inner plate.

4. (canceled)

5. (canceled)

6. The chain guider as claimed in claim 1, wherein a width of the inner plate is wider than that of the outer plate.

7. The chain guider as claimed in claim 1, wherein the inner plate is made of metal sheet.

8. (canceled)
